(19) United States
(12) Patent Application Publication
(10) Pub. No.: US 2008/0034650 A1
(43) Pub. Date: Feb. 14, 2008

(54) Gardening Stake Kit for Plant Support, Nourishment and Training

(76) Inventor: Forrest D. Williams, Fairfax, VA (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/463,343

(22) Filed: Aug. 9, 2006

(51) Int. Cl. A01G 29/00; A01G 17/14

(52) U.S. Cl. 47/48.5; 47/47

(57) ABSTRACT

A gardening stake kit for plant training includes a plurality of shaft segments that are connectable end to end to form a shaft of variable lengths. A plurality of grooves are formed in an outer periphery of each shaft segment. A pointed base is connectable to one end of a shaft segment, and a plurality of arms that are connectable to the grooves formed in each shaft segment. The grooves are formed by etching, molding, cutting or other means. Preferably, the grooves are formed at more than one angle relative to the top and bottom of each shaft segment and, preferably, include horizontal grooves as well as angular grooves. Further, the arms engage the grooves so as to prevent sliding and to secure the attached plant in manner desired by the user.

### BACKGROUND OF THE INVENTION

1. Field of the Invention

The present invention relates to a gardening stake kit for training, supporting and nourishing different types of plants. In particular, the invention is concerned with a device that can be extended as a plant grows vertically, such as a tomato plant or tall flowers, to ensure that the plant remains upright as it grows, thereby assisting in greater growth that is more vertical. The resulting plant produces greater yield per plant in a smaller amount of space. The invention is further concerned with an extendable plant stake that includes a pointed base that contains a catch basin for fertilizer and water, and tubes through the base sidewalls to deliver fertilizer to the roots.

2. Background Description

The use of gardening stakes or cages designed to assist a plant in remaining upright during its growth have been described in various patents. Besides providing support for vertically growing plants, gardening stakes also serve to prevent bending and breaking of plant stems during bad weather, heavy winds, or just the weight of growing fruit. Thus, gardening stakes tend to result in taller plants and more abundant supplies of fruit.

However, the stakes or cages used in the gardening industry tend to be made of iron or steel that tends to rust over time, even if galvanized. There also exist stakes of bamboo, wood and other organic types that bend and rot over time. In addition, these stakes and cages are also fixed in height so they can only support a plant up to a certain height, thus resulting in stem bending and breakage as well as less fruit production as the plants grow taller. Although gardening stakes have been introduced that are made of stronger, rustproof material, they tend to be fixed in height and are not designed to add further vertical extensions. These stakes also tend to include string, wire, or other devices that connect the plant to the stake which often take a great amount of time to install and then remove at season's end. Also, the stake engagement mechanisms in the prior art tend to be insecure and slide along the stake, thus resulting in less support for the plant. Finally, there has been no means demonstrated by which the dispensing of liquid fertilizer to the plant roots has been incorporated in a gardening stake mechanism.

Currently, the undersigned is not aware of any commercially available gardening stakes or kits that address these problems.

### SUMMARY OF THE INVENTION

It is an exemplary object of this invention to provide a gardening stake kit for plant training, support and nourishment that comprises a plurality of shaft segments that are connectable end to end to form a shaft of variable lengths. The shaft segments preferably include a plurality of grooves formed in an outer periphery of the shaft segment. A pointed base is preferably connectable to one end of a shaft segment. Preferably, the pointed base contains a basin to collect liquid fertilizer. Capillary tubes are preferably formed on the sidewalls of the base and allow flow of liquid fertilizer from the basin, through the tubes to exits formed on the outside of the base. This system allows liquid fertilizer to be applied more directly to a root system of a plant. A plurality of arms are preferably connectable to the grooves formed in each shaft segment, where the user can attach as many or as few arms as desired, and can use arms of varying lengths to accommodate the needs of the separate branches of the plant.

The shaft segments of the gardening stake kit of the present invention are preferably made of sturdy, weather and rust resistant material, such as metal, plastic or combinations thereof. A rubber seal may be placed on the end of the shafts to assist in water resistance. The shaft segments can be constructed in a variety of sizes in order to conform to the size of plant that needs support (e.g., ranges from small for an indoor potted plant, to large for an outdoor plants) and to accommodate a variety of issues from manufacturing, packaging of the gardening stake kit, and shipping. The shaft segments further include grooves that are formed by etching, molding, cutting, or other means into the shaft in a 360-degree periphery. These grooves are preferably at different angles in each shaft segment and spaced sufficiently apart to provide flexibility with regard to preferred point of attachment. Particularly, the grooves can be formed at more than one angle relative to the top and bottom of each shaft segment and, preferably, include horizontal grooves as well as angular grooves ranging between 10° and 80° and between 100° and 170°. The grooves may fully encircle the outer periphery of the shaft segments. Alternatively, the grooves can be formed on only a portion of the periphery or include a hole within a groove to secure the end of an attachable arm. The grooves prevent the arm from sliding or disengaging from the shaft segment when tensile pressure or weight is applied by the plant, which is engaged with the opposing end of the arm. Alternate attachment methods could include Velcro, poke-through plastic heads into holes in the shaft, screw eyes, or even glued points for attachment.

The arms can be constructed of various types of materials and in different lengths. The arms should be in tension and have malleable end portions for easier tying and removal. Preferably, the arms are made from a material selected from the group consisting of metal, plastic, rope, rubber, chain, or combinations thereof. Further, the arms may include hooked ends so that one end can engage with a groove, while the other end can engage a plant (i.e., branches of the plant can be trained to the hooked end). Alternatively, the arms can be comprised of circular looped ends, or ends that are constructed to wrap around the shaft segment and be secured within a groove, or include methods for attachment in each of the above descriptions.

A pointed or spiked base is preferably included with the kit in order to easily secure the shaft assembly into the ground. The base portion is preferably connectable at one end to one of the shaft segments. Preferably, the base portion includes a catch basin for liquid fertilizer and/or water, as well as a plurality of holes in the pointed end for distribution of liquids. Preferably, the kit further includes an insertion tool that connects to and disconnects from one end of the base. The insertion tool is inserted into one end of the base to assist in inserting or removing the base from the ground or soil. The base may also be heavier than the shaft segments to assist in stability of the training system during wind, rain, or other outdoor conditions. The base may also have various lengths to ensure vertical support in various soil consistencies and various heights intended for the stake.

A cap is further included in the gardening stake kit to further aid in water resistance. The cap can be built into the top of the shaft assembly built just for this purpose, or connectable at one end to the top of one of the shaft segments.

The plurality of shaft segments are joined together so as to easily engage and disengage with one another. Preferably, the shaft segments can include threaded connectors for joining together two or more shaft segments. Alternatively, the shaft segments can include bayonet connectors for joining together two or more shaft segments. Other types of connections (e.g., plunger and hole, rod and hook, etc.) may also be used. Further, rubber seals may be formed at the connection points between shaft segments to assist in water resistance. The chief requirement is that the connection allows for securely fixing one segment to another end to end. The stem assembly of the gardening stake kit can preferably expand to be as high as the corresponding plant grows to be.

In operation, a user positions the base in the ground or soil adjacent to at least one plant, or adjacent to a future location of the plant by using the insertion tool device. Then, the user connects the shaft segments to the base. As previously described, each of the shaft segments are connectable end-to-end to form a shaft of variable length and each shaft includes a plurality of grooves formed in its outer periphery. Finally, as the plant initially grows and its branches need the support, the user connects one or more arms to at least one of the shaft segments so that a portion of a plant can be connected to a free end of an arm and a connecting end of said arm member is positioned in a groove. In addition, the user can connect at least two arm members of different lengths. Further, the user can connect at least two arm members at different angles relative to a shaft segment. As the plant grows, the user can connect more shaft segments and arm members to assure continued vertical training and support of the plants. All the above will provide controlled and secured vertical growth that will allow greater yields from both perspectives of each individual plant, as well as greater efficiency of use of land in growing areas.

### BRIEF DESCRIPTION OF THE DRAWINGS

The foregoing and other objects, aspects and advantages will be better understood from the following detailed description of a preferred embodiment of the invention with reference to the drawings, in which:

FIG. 1A is an exploded view of one embodiment of a shaft assembly of the gardening stake kit;

FIG. 1B shows a shaft segment according to an alternative embodiment;

FIGS. 2A through 2C shows various types of arms of the gardening stake kit;

FIG. 3A is a broken and enlarged view of a hooked arm engaging with the grooves in the shaft segment according to one embodiment;

FIG. 3B is a broken and enlarged view of a hooked arm portion engaging with the grooves in the shaft segment according to another embodiment of the present invention;

FIG. 3C is a broken and enlarged view of a hooked arm portion engaging with the grooves in the shaft segment according to yet another embodiment;

FIG. 4A shows a gardening stake kit used in training and nourishing a plant;

FIG. 4B shows a gardening stake kit used in training and nourishing a small, but growing plant;

FIG. 5 shows a base and insertion tool according to the present invention;

FIG. 6A shows a base removal tool according to the present invention; and

FIG. 6B shows operation of the base removal tool according to the present invention.

### DETAILED DESCRIPTION OF THE PREFERRED EMBODIMENTS OF THE INVENTION

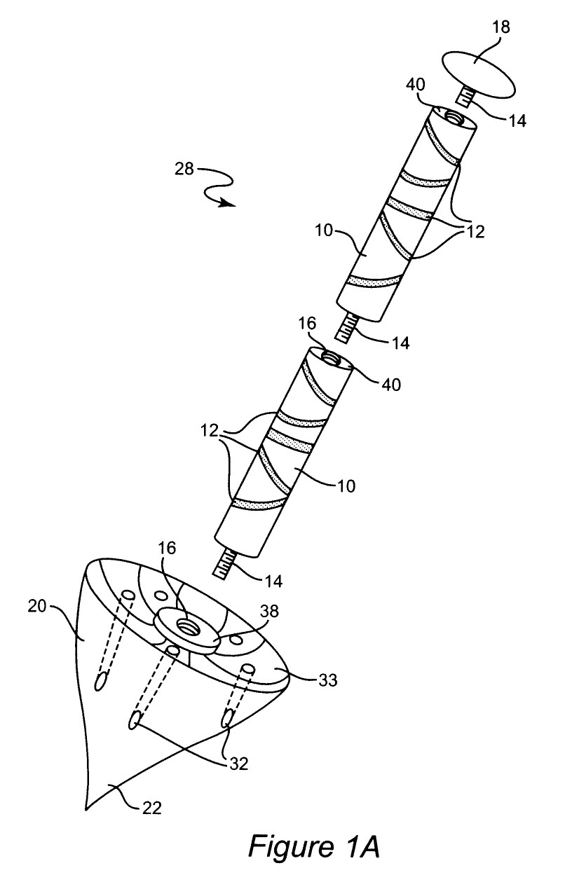

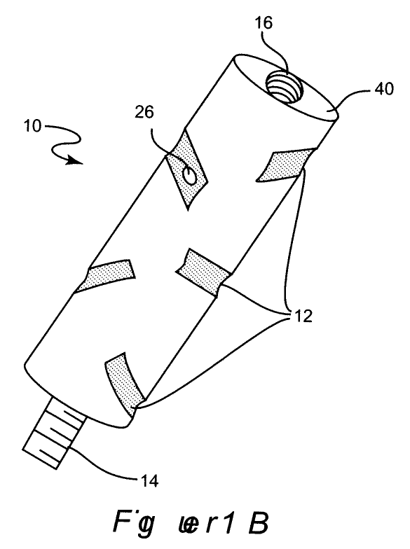

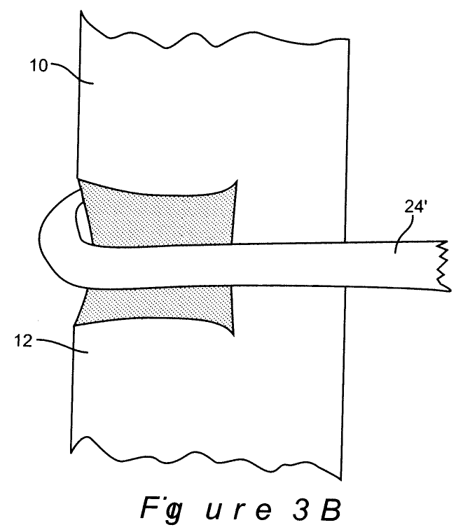

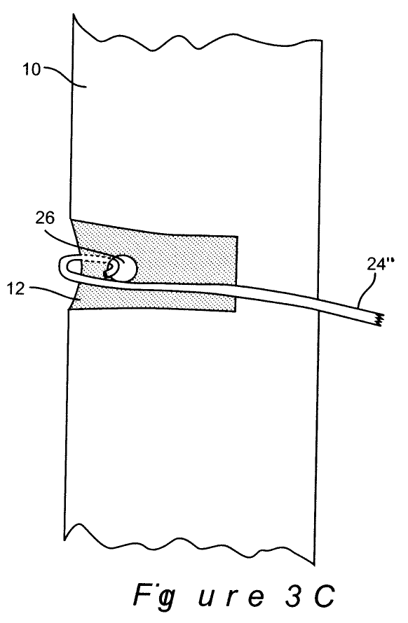

Referring now to the drawings, and more particularly to FIG. 1A, there is shown an exploded view of one embodiment of a shaft assembly 28. The shaft assembly 28 includes at least one shaft segment 10, a cap 18 and a pointed base 20 with a catch basin 33. The shaft segment 10 includes a plurality of grooves 12. As shown in FIG. 1A, the grooves 12 can be formed to fully encircle the outer periphery of the shaft segment 10. Alternatively, the grooves 12 can be formed along only a portion of the outer periphery of the shaft segment 10 (as shown in FIG. 1B). In addition, as shown in FIG. 1B, the grooves 12 can include a hole 26 used for threading an arm 24 (as shown in FIG. 3C) through. Further, the grooves 12 are formed at more than one angle relative to the top and bottom of each shaft segment and, preferably, include horizontal grooves as well as angular grooves ranging between 10° and 80° and between 100° and 170° (e.g., angles of 45° and 135°).

The shaft segment 10 is preferably formed of a sturdy, weather- and rust-resistant material (e.g., non-ferrous metal, plastic, combination thereof, etc.) and can be constructed in various sizes in order to conform to the user's needs (e.g., outdoor or indoor use, or plants that are small or large). The shaft segment 10 preferably includes a spiral ridge 14 on one end and a cylindrical hole 16 on the opposing end, thus allowing a plurality of shaft segments 10 to thread together. Preferably, a seal 40, which can be comprised of rubber, for example, is formed at the connection points between attached shaft segments 10 for increasing water resistance. Alternatively, the shaft segments 10 can include bayonet connectors (not shown) or other connectors for joining together two or more shaft portions end to end. Therefore, engagement and disengagement between shaft segments is simplified, thus making it easier to enlarge or shorten the height of the shaft assembly 28. Although the shaft segment 10 is shown to threadably engage and disengage, other types connecting mechanisms can be applied within the scope of the present invention (e.g., press-fitting, “lock-and-key”, etc.).

The shaft segment 10 is also preferably constructed to easily engage and disengage with a cap 18 and pointed base 20. The cap 18 can ensure a water resistant seal is formed at the top of the shaft assembly 28, as well as to act as a cover for the sharper edges of the top of a shaft segment 10. As shown in FIG. 1A, the base 20 is preferably comprised of a pointed tip 22 and a cylindrical hole 16. The pointed tip 22 is constructed in order to easily be inserted into the ground or soil. As previously discussed, although the shaft segments 10, cap 18, and base 20, are shown to threadably engage and disengage with one another, other types engagement/disengagement mechanisms can be applied within the scope of the present invention (e.g., bayonet, press-fitting, “lock-and-key”, etc.). Further, the base 20 preferably includes a plurality of holes 32 for distributing fertilizer. Preferably, the holes are tapered to keep out dirt and other debris that can clog the holes 32. To use the fertilizer feature of the present invention, solid fertilizer is dropped onto the base. When a user wants to distribute fertilizer to the soil, water may be poured into the top liquid catch basin 33 of the base 20 where the fertilizer breaks down and is distributed through the holes 32 in the base 20. Alternately, liquid fertilizer could be poured directly into the catch basin and provide the same nourishment to the roots via capillary action through the holes 32. A hose connection (not shown) could be provided in the base 20 or a shaft segment 10. The shaft segments 10, as well as the base 20, can be constructed to be hollow in order to allow water to flow through each segment of the shaft assembly 28 in order to activate the fertilizer.

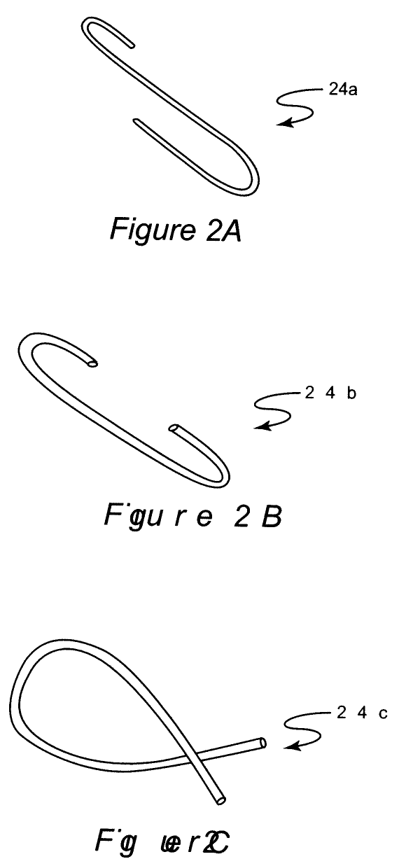

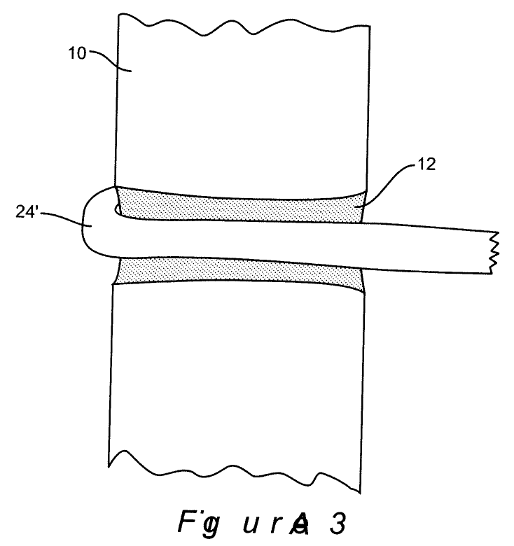

Now referring to FIGS. 2A, 2B and 2C, there are shown several types of arms 24a, 24b, 24c. As can be seen, the arms 24a, 24b, 24c can be constructed in various shapes and sizes. For example, FIG. 2A shows the arm portion 24a to be formed as an “S” shaped hook, FIG. 2B shows a “C” shaped hook, and FIG. 2C shows a looped end of an arm 24c which wraps around the shaft 10 into a groove 12. The arms 24a, 24b, 24c can be constructed of various types of materials (e.g., metal, plastic, rubber, etc.) so long as they are in tension and have malleable ends that are strong enough to hold the plant to a shaft segment 10.

FIGS. 3A, 3B and 3C all show broken and enlarged views of an arm 24′ engaging with the grooves 12 in a shaft segment 10. Specifically, FIG. 3A shows an arm 24′ engaging the groove 12 in the shaft segment 10. The groove 12 is formed to fully encircle the outer periphery of the shaft segment 10 (as shown in FIG. 1A). The arm 24 is supported within the groove 12 at all points along the length of the shaft segment 10. Therefore, the groove 12 supports the arm 24 so that when movement occurs (due to weather, plant growth, etc), the groove 12 prevents the arm 24 from sliding or disengaging. FIG. 3B shows the arm 24′ engaging the groove 12 that is formed, cut or etched along only a portion of the outer periphery of the shaft segment 10 (as shown in FIG. 1B). FIG. 3C shows the arm 24″ engaging the groove 12 (as shown in FIG. 1B) and the hooked end portion of the arm 24″ loops through a hole 26 formed in the groove 12. This ensures that the arm 24 is securely attached to the shaft segment 10.

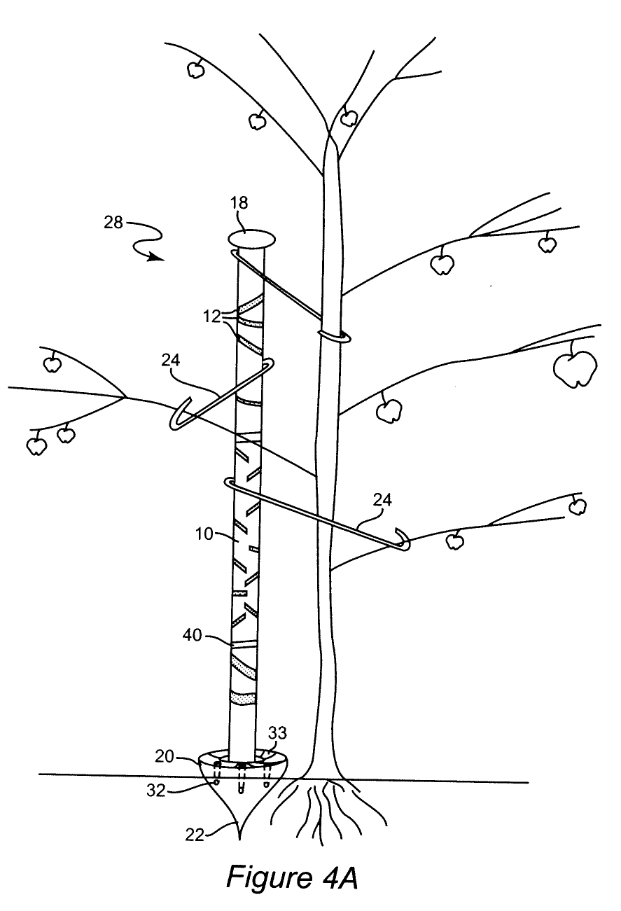

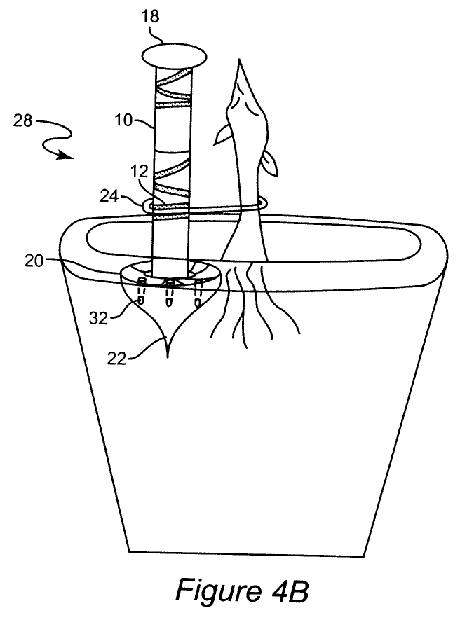

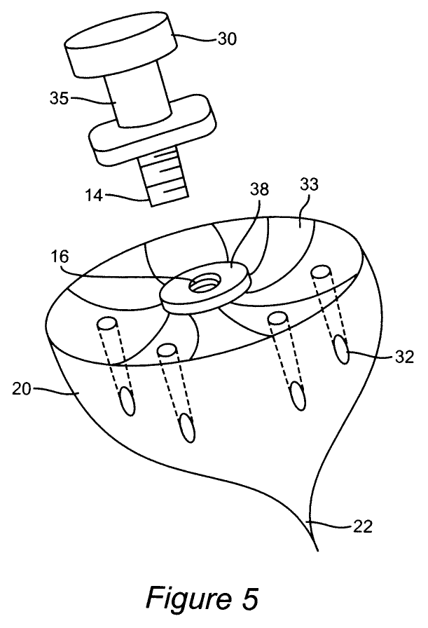

Referring now to FIGS. 4A and 4B, it should be understood that the shaft assembly 28 can be used in outdoor and indoor settings, and with small and larger plants. The pointed base 20 is inserted into the ground using the insertion tool 30 shown in FIG. 5. The insertion tool 30 has a top portion with a head and neck 35 shape so as to engage with a removing tool 34, which will be discussed in further detail below, as well as to be graspable by a user's hand. Prior to assembling the shaft assembly 28, the insertion tool 30 is inserted into the cylindrical hole 16 of the base 20. A disk 38 is placed around the outer perimeter of the cylindrical hole 16. The disk 38 is designed to absorb the downward force caused by driving the insertion tool 30 or shaft assembly 28 into the ground, thus preventing breakage of the base 20. Once the insertion tool 30 is inserted, the user positions the pointed tip 22 of the base 20 at a desired location adjacent to a current or future plant. Next, the user pounds, twists, pushes, or otherwise forces the insertion tool 30 to insert the base 20 into the ground. Once inserted into the ground, the insertion tool 30 is removed from the base 20 and a shaft segment 10 can be connected to the base 20.

Once the shaft assembly 28 is inserted into the ground next to a plant, a user hooks (or otherwise attaches) one end of an arm 24 around a stem or branch of a plant that needs support. The other end of the arm 24 is hooked (or otherwise attached) to a groove 12 in a shaft segment 10. The user can attach as many arms as necessary to ensure that the plant is adequately supported. As the plant grows vertically, shaft segments can be added to the stem assembly 28 to ensure that the plant is supported at all stages of growth. Because the plant will have sufficient support during its life span, the plant can, for example, produce large amounts of fruit and have a longer life span.

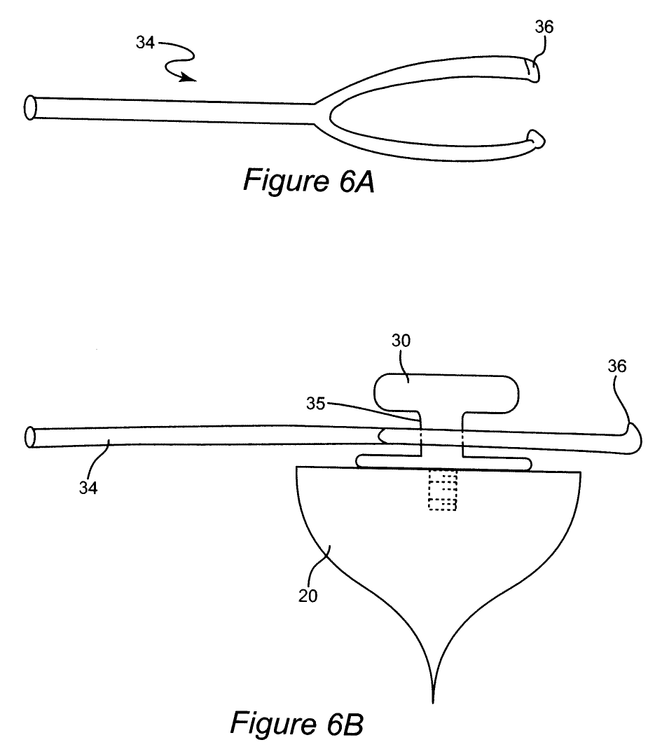

Referring now to FIGS. 6A and 6B, there is shown a base removing tool 34 that assists in removing the insertion tool 30 and base 20 from the ground or soil. When a user wants to remove the base 20 from the ground, the user disconnects the stem segment 10 from the base 20 and inserts the insertion tool 30 into the cylindrical hole 16 of the base 20, as previously described. Then, the user pulls the insertion tool 30 away from the ground using the removing tool 34 shown in FIG. 6A, thus removing the base 20 from the ground. To use the removing tool 34, one slides the fork-shaped portion of the tool 34 under the head of the insertion tool 30 until the smallest part of the fork engages the neck 35 of the insertion tool 30. Then, the user lifts up or pries the removing tool 34 so that the insertion tool 30 and attached base 20 are removed from the ground. The removing tool 34 end points have tines 36 which can be used downward in earth, or pointed up if a support means is used for the end of the removing tool 34.

While the invention has been described in terms of its preferred embodiments, those skilled in the art will recognize that the invention can be practiced with modification within the spirit and scope of the appended claims.

I claim:

1. A kit for training plants for plant growth, comprising:
a plurality of shaft segments which are connectable end to end to form a shaft of variable lengths;
a plurality of grooves formed in an outer periphery of each of said shaft segments;
a base which is connectable at one end to at least one of said plurality of shaft segments, said base including a pointed end; and
a plurality of arms, each of said plurality of arms being connectable to one or more of said plurality of grooves formed in said outer periphery of each of said shaft segments.

2. The kit of claim 1, further comprising an insertion tool connectable to and disconnectable from said one end of said base, said insertion tool being selectively connected to said base during insertion or removal of said base from ground.

3. The kit of claim 1, said base further comprising a means for fertilizer disbursement, and
wherein said means for fertilizer disbursement is comprised of a basin capable of holding liquids and a plurality of holes distribution of said liquids.

4. The kit of claim 1 wherein said plurality of grooves in said outer periphery of each of said shaft segments include grooves formed at more than one angle relative to a top and a bottom of each shaft segment.

5. The kit of claim 4 wherein at least one shaft segment includes a first groove which is horizontal to said top and said bottom, and a second groove which is at an angle between 10° and 80°, and a third groove which is at an angle between 100° and 170°.

6. The kit of claim 1 wherein each of said plurality of arms includes a first hooked end for engagement with a groove of said plurality of grooves.

7. The kit of claim 6 wherein each of said plurality of arms includes a second hooked end for engagement with a plant.

8. The kit of claim 1 wherein at least one of said plurality of arms includes a circular loop at one end for engagement with a groove of said plurality of grooves.

9. The kit of claim 1 wherein at least one of said plurality of arms has a first end which wraps around a shaft segment of one of said plurality of shaft segments, and is secured to said shaft segment within a groove of said plurality of grooves.

10. The kit of claim 1 wherein ends of each of said plurality of shaft segments include threaded connecters for joining together two or more shaft segments.

11. The kit of claim 2 further comprising a base removing tool, said base removing tool engages with said insertion tool for removing said base from the ground when said insertion tool is connected to said one end of said base.

12. The kit of claim 1 wherein each of said arms are made from a material selected from the group consisting of metal, plastic, rope, rubber, chain, or combinations thereof.

13. The kit of claim 1 wherein different arms of said plurality of arms are of different lengths.

14. The kit of claim 1 wherein said plurality of shaft segments are made form metal, plastic, or combinations thereof.

15. The kit of claim 1 further comprising a cap member which is securable to at least one of said plurality of shaft members.

16. A method of training plants for growth, comprising the steps of;
positioning a base member in ground adjacent to an existing or future location of at least one plant;
connecting at least one of a plurality of shaft segments to said base member, each of shaft segments being connectable end to end to form a shaft of variable length, each of said shaft segments having a plurality of grooves formed in an outer periphery; and
connecting one or more arm members to at least one of said plurality of shaft segments so that a portion of a plant can be connected to a free end of said arm member and a connecting end of said arm member is positioned in a groove of said plurality of grooves.

17. The method of claim 16 wherein said step of connecting one or more arm members connects at least two arm members of different lengths.

18. The method of claim 16 wherein said step of connecting one or more arm members connects at least two arm members at different angles relative to said shaft.

19. The kit of claim 1, wherein said plurality of grooves fully encircle said outer periphery of each of said shaft segments.

20. The kit of claim 6, wherein each of said plurality of arms engage with a hole in a groove formed in said plurality of grooves.
